(19) United States
(12) Patent Application Publication
(10) Pub. No.: US 2005/0144166 A1
(43) Pub. Date: Jun. 30, 2005

(54) Method for assisting in automated conversion of data and associated metadata

(76) Inventors: Frederic Chapus, Aliso Viejo, CA (US); Herman Fischer, Woodland Hills, CA (US)

Correspondence Address: BURNS DOANE SWECKER & MATHIS L L P, POST OFFICE BOX 1404, ALEXANDRIA, VA, 22313-1404, US

(21) Appl. No.: 10/996,449

(22) Filed: Nov. 26, 2004

Related U.S. Application Data
(60) Provisional application No. 60/524,901, filed on Nov. 26, 2003.

(51) Int. Cl. G06F 7/00

(52) U.S. Cl. 707/6

(57) ABSTRACT

An exemplary method for the automated, or semi-automated, conversion or reconciliation of metadata from one form into another, includes one or more of: a) identifying data elements and their associated metadata in electronic file(s); b) transforming this metadata into an intermediate metadata format for later use in production of new metadata structure(s); c) developing bodies of re-usable rules for the transformation or mapping of data sets encoded using one set of metadata into another data set encoded using a different set of metadata; d) developing bodies of re-usable metadata sets and rules for the transformation or mapping of metadata into an intermediate metadata structure; e) developing of bodies of re-usable metadata sets and rules for the transformation or mapping of metadata of an intermediate metadata structure into new metadata structure(s); and f) an efficient method for capture of conversion and validation rules.

### RELATED APPLICATIONS

This application claims priority to U.S. Provisional Application No. 60/524,901 filed in the U.S. Patent and Trademark Office on 26 Nov. 2003. U.S. Provisional Application No. 60/524,901 is hereby incorporated by reference.

### BACKGROUND

XBRL (Extensible Business Reporting Language) is one of the XML (extensible Markup Language) formats. XBRL provides a robust method of expressing complex metadata and data semantics. The specifications for XBRL have been produced under the auspices of XBRL International Inc., which is a not-for-profit consortium of approximately 200 companies and agencies. XBRL provides a common platform for critical business reporting processes and is intended to improve the reliability and ease of communicating data (especially financial data) among users internal and external to the reporting enterprise.

### SUMMARY

An exemplary method for the automated, or semi-automated, conversion or reconciliation of data and their associated metadata from one form, schema, taxonomy, or standard into another, includes one or more of: a) identifying data elements and their associated metadata in electronic file(s); b) transforming this metadata into an intermediate metadata format for later use in production of new metadata structure(s); c) developing bodies of re-usable rules for the transformation or mapping of data sets encoded using one set of metadata into another data set encoded using a different set of metadata; d) developing bodies of re-usable metadata sets and rules for the transformation or mapping of metadata into an intermediate metadata structure; e) developing of bodies of re-usable metadata sets and rules for the transformation or mapping of metadata of an intermediate metadata structure into new metadata structure(s); and f) an efficient method for capture of conversion and validation rules.

An exemplary method for converting a first set of data having a first logical structure into a second set of data having a second logical structure, wherein the first and second sets include metadata, includes classifying an element of the first set of data, automatically selecting a rule relating the element of the first set of data to the second set of data, based on the classification, executing the rule to convert the element of the first set of data to an element of the second set of data based on the selected rule, storing a logical correspondence between the element of the first set of data and the element in the second set of data based on the conversion, in the event information is received from a user in response to an automatic query performed by execution of the rule, and repeating the classifying, converting and storing for each element in the first set of data.

An exemplary method for converting a first set of data elements having a first logical structure based on conceptual metadata of a first schema or a first taxonomy, into a second set of data elements having a second logical structure associated with conceptual metadata of a second schema or a second taxonomy, wherein the first and second sets include conceptual metadata from the corresponding schema or taxonomy, contextual metadata and fact values, includes classifying a data element of the first set of data, the classifications being based on logical correspondences between concepts of the first and second schemas or taxonomies and including a) a classification wherein the semantic of a concept of the first schema or taxonomy is identical to a concept of the second schema or taxonomy, b) a classification wherein a concept of the first schema or taxonomy is related to a concept of the second schema or taxonomy by a mathematical function that converts the fact value associated with the concept of the first schema or taxonomy into a fact value associated with the corresponding concept of the second schema or taxonomy, c) a classification wherein conversion of a concept of the first schema or taxonomy requires a selection among different options for conversion of a fact value associated with the concept of the first schema or taxonomy into a fact value associated with a corresponding concept of the second schema or taxonomy, and d) a classification wherein conversion of a concept of the first schema or taxonomy requires additional information for conversion of a fact value associated to with the concept of the first schema or taxonomy into a fact value associated with a corresponding concept of the second schema or taxonomy, automatically selecting a rule relating the data elements of the first set of data to the second set of data, based on the classification, executing the rule to convert the element of the first set of data to an element of the second set of data based on the selected rule, storing a logical correspondence between the element of the first set of data and the element in the second set of data based on the conversion, in the event information is received from a user in response to an automatic query performed by execution of the rule, and repeating the classifying, converting and storing for each element in the first set of data.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates an exemplary business document.

FIG. 2 illustrates data and metadata of the document shown in FIG. 1.

FIG. 3 illustrates a presentation view corresponding to the document of FIG. 1, with an XBRL expression of associated metadata below it.

FIG. 4 illustrates a taxonomy calculation view corresponding to the document of FIG. 1 with an XBRL expression of associated metadata below it.

FIG. 5 illustrates exemplary creating and saving a mapping design context from data source before creating an Instance document.

FIG. 6 illustrates an exemplary embodiment in the process of creating an instance document.

FIG. 7 illustrates an exemplary process for creating a rule that can be used in conversion and/or analysis of Instance documents.

FIG. 8 illustrates an exemplary embodiment wherein a previously specified rule is applied.

FIG. 9 illustrates exemplary creation of a taxonomy conversion rules repository.

FIGS. 10A, 10B illustrate exemplary conversions from one standard to another standard.

FIG. 11 illustrates an exemplary process for automating conversion from one standard to another standard.

FIGS. 12A, 12B illustrate exemplary structures of metadata.

FIG. 13 illustrates an exemplary application employing metadata structure such as shown in FIGS. 12A, 12B.

### DETAILED DESCRIPTION

An exemplary method for the automated, or semi-automated, conversion or reconciliation of metadata from one form into another, includes one or more of: a) identifying data elements and their associated metadata in electronic file(s); b) transforming this metadata into an intermediate metadata format for later use in production of new metadata structure(s); c) developing bodies of re-usable rules for the transformation or mapping of data sets encoded using one set of metadata into another data set encoded using a different set of metadata; d) developing bodies of re-usable metadata sets and rules for the transformation or mapping of metadata into an intermediate metadata structure; e) developing of bodies of re-usable metadata sets and rules for the transformation or mapping of metadata of an intermediate metadata structure into new metadata structure(s); and f) an efficient method for capture of conversion and validation rules.

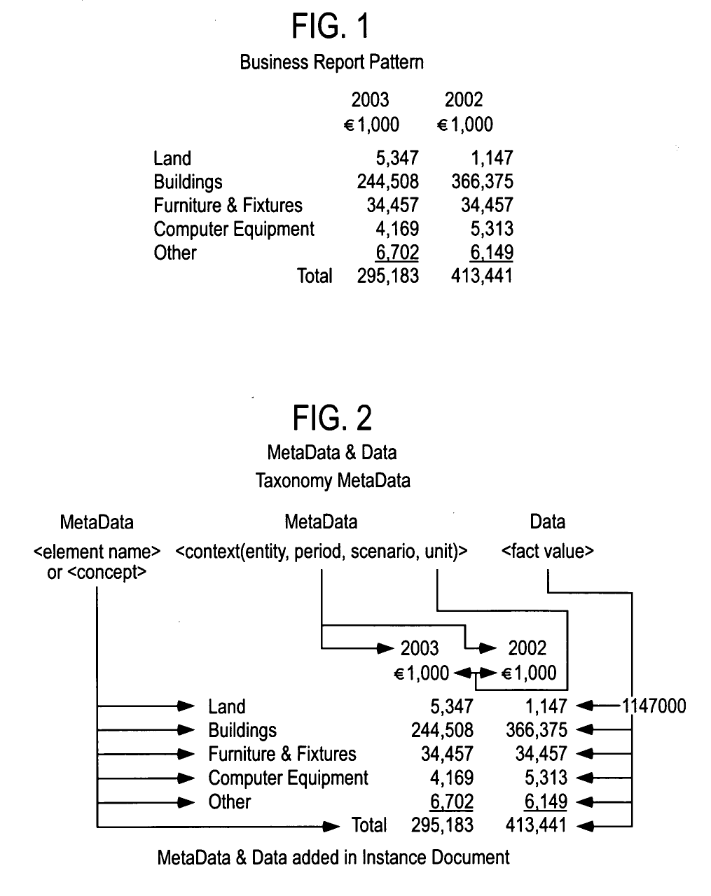

FIG. 1 illustrates a typical business document, for example a portion of a possible Business Report from an organization. The XBRL language refers to such documents as Instance documents—an Instance document represents a specific instance of a combination of data and metadata. In particular, an XBRL instance document is an XML document which complies with the XBRL specification. It is typically used to describe financial data for regulatory or reporting requirements. Each item included in an XBRL instance document will need to be defined in the appropriate XBRL taxonomy, and if not must be defined in an extension taxonomy.

An XBRL “Taxonomy” defines the items allowed in an XBRL instance document in a particular domain or vocabulary. It consists of a taxonomy schema document and may also include one or more linkbases. See Also: Linkbase, Taxonomy Schema Document, XBRL Instance Document. A taxonomy schema document is a part of an XBRL taxonomy. It is used to define the list of items (and the types of those items) allowed in a given domain or vocabulary. Taxonomy schema documents are required to be compliant with both the schema for schemas and xbrlinstance.xsd. They will therefore use the schema for schemas namespace and will import xbrlinstance.xsd.

An extension taxonomy may include a taxonomy schema document and one or more linkbases. It provides for the definition of XBRL data items which are not already defined in the given domain taxonomy. One use for this is to provide for company specific data in annual reports, where the general accounting taxonomy may not be sufficient to describe all the data included in the XBRL instance document. An extension taxonomy schema document is a taxonomy schema document that is provided as part of an extension taxonomy.

Instance documents can be encoded in a vast variety of forms; XBRL is but one example. Instance documents can be found in other, often proprietary forms, such as in the form of a Microsoft Excel spreadsheet.

Usually when such documents are produced or generated via electronic means, they are constructed by the programmatic combination of data and metadata. The resulting documents themselves can of course be electronic as well as physical or printed documents.

This metadata can be of a number of types. Exemplary types can include, for example: metadata describing the nature of the data elements themselves (their type, such as numeric or textual, scale, size, etc., and whether they are independent, or derived from the combination of other data elements; metadata describing the structural relationships between various data elements, such as parent-child or equivalency relationships; and metadata describing how the data elements will appear in the final documents, such as language, font, format, location, scale, size, etc.

FIG. 2 illustrates data and some metadata that can underlie the document shown in FIG. 1. If we decompose and analyze the data and (some of) the metadata underlying this short Instance document, we can see: raw data (“Fact Values”) such as a 2002 land value of Euro 1147000; contextual metadata, for example context years of interest; 2002 and 2003; and descriptive metadata such as “Element Names” or “Concepts”which are to be displayed for human-readability of the Instance document (e.g., “Land”, “Buildings”, etc.). Many forms of metadata can be important for Instance document production. In an exemplary embodiment, we concentrate on a subset, defined in XBRL as follows: a) Calculation metadata that is used to allow basic operations to be defined for sets of elements and used to check that these operations have been correctly performed when a document is produced; and Presentation metadata that describes how the data elements will be presented in documents in a human-readable and sensible form. These two types of metadata are examples of the larger class of XBRL Taxonomy Metadata.

In order to understand, manipulate, validate and/or modify Instance document data, a set of Instance document metadata exist for every Instance. At a more abstract level, a set of Instance documents, each member (document) of the set containing different data but the same metadata, is described in XBRL via a document Taxonomy. For example, the various Instances of a set of Annual Reports for a company will contain different data for each year's Report, but the underlying metadata for each Instance is derived from the underlying XBRL Taxonomy for the Annual Report.

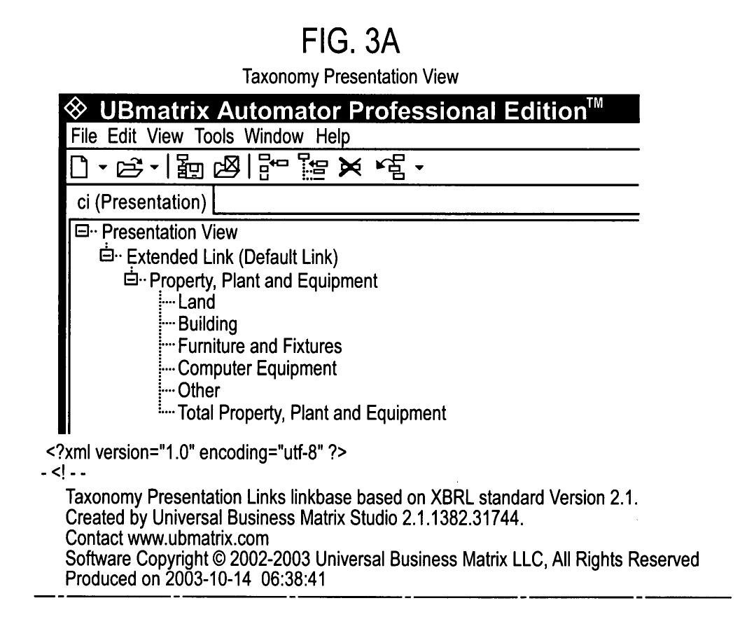

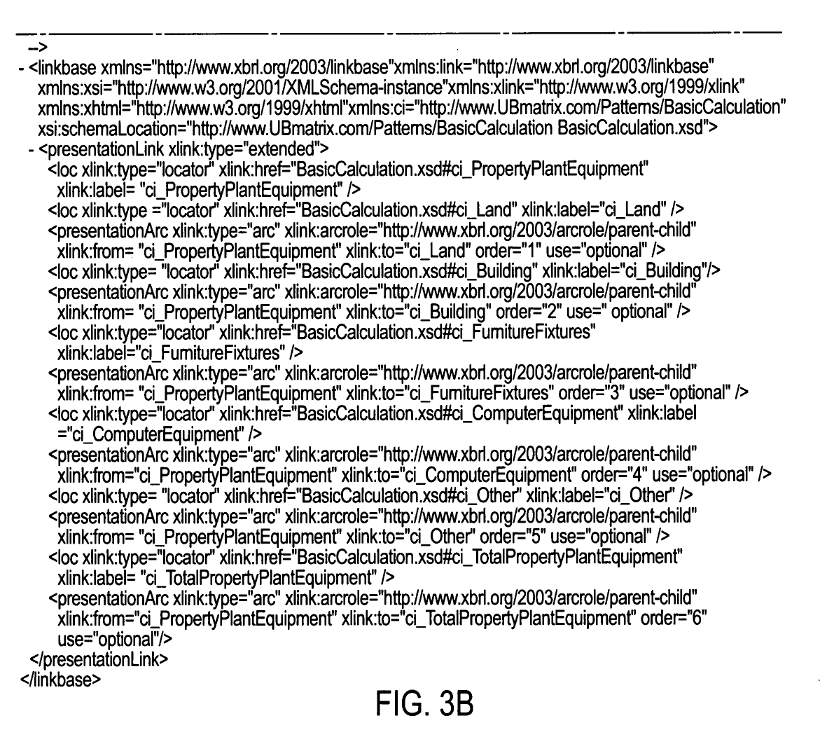

FIG. 3 shows a taxonomy Presentation view or structure, in accordance with exemplary embodiments, with an XBRL expression of the associated metadata below.

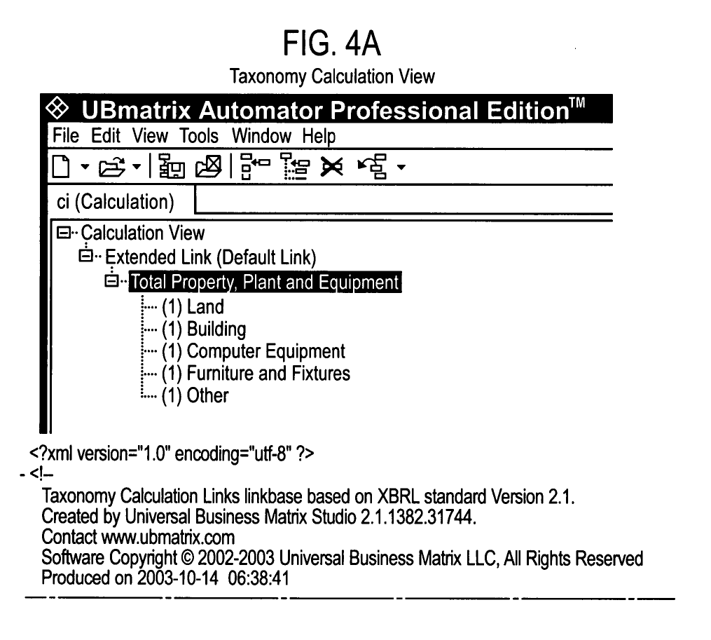

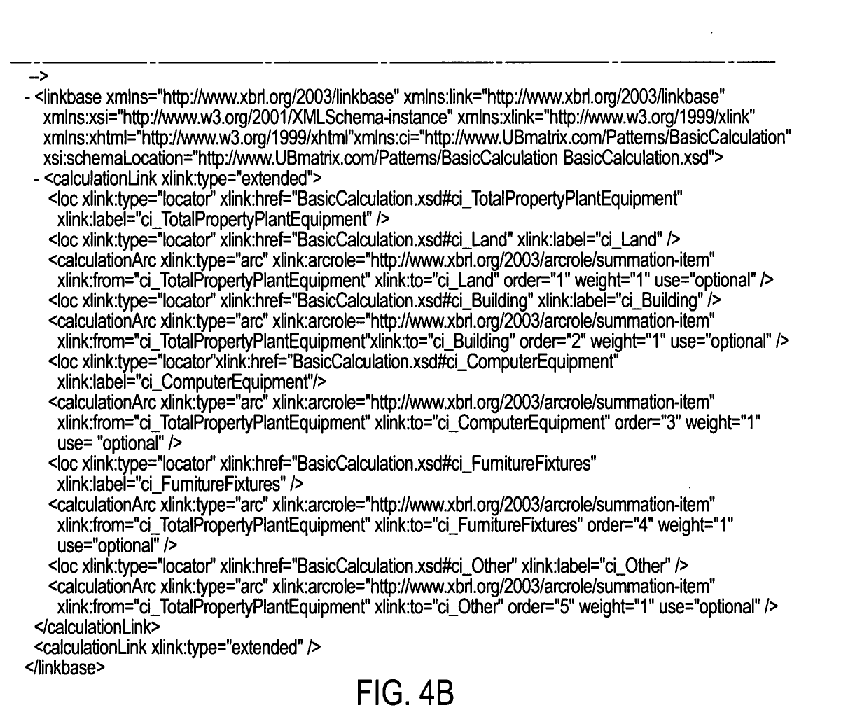

FIG. 4 shows a taxonomy Calculation view or structure, in accordance with exemplary embodiments, with an XBRL expression of the associated metadata below.

Just as there are a large (often virtually unbounded) number of possible data sets (Instance documents) possible for a given metadata set (Taxonomy), there are a large possible number of Taxonomies which can describe a single data set, or describe a data set which is fully dependent upon, and derived from, a given data set.

For example, consider a financial data set (an Instance document) produced in one country (the source) that may be consumed in another country (the target) in a different form. These different forms can be expressed via differences between the source and target Taxonomies. Conversions (such as for monetary currency), element naming, and different accounting rules or methods of calculation for sums and averages are all examples of metadata differences which are reflected in different source and target Taxonomies, even when the same Instance data set is being used by both parties.

Creation of specific, direct, one-to-one mappings from every relevant source Taxonomy to every relevant target Taxonomy can be inefficient. In accordance with exemplary embodiments, efficiency is improved by mapping the source Taxonomy into a single intermediate standard reference metadata, and then constructing or linking specific target Taxonomies via mapping from that standard reference metadata.

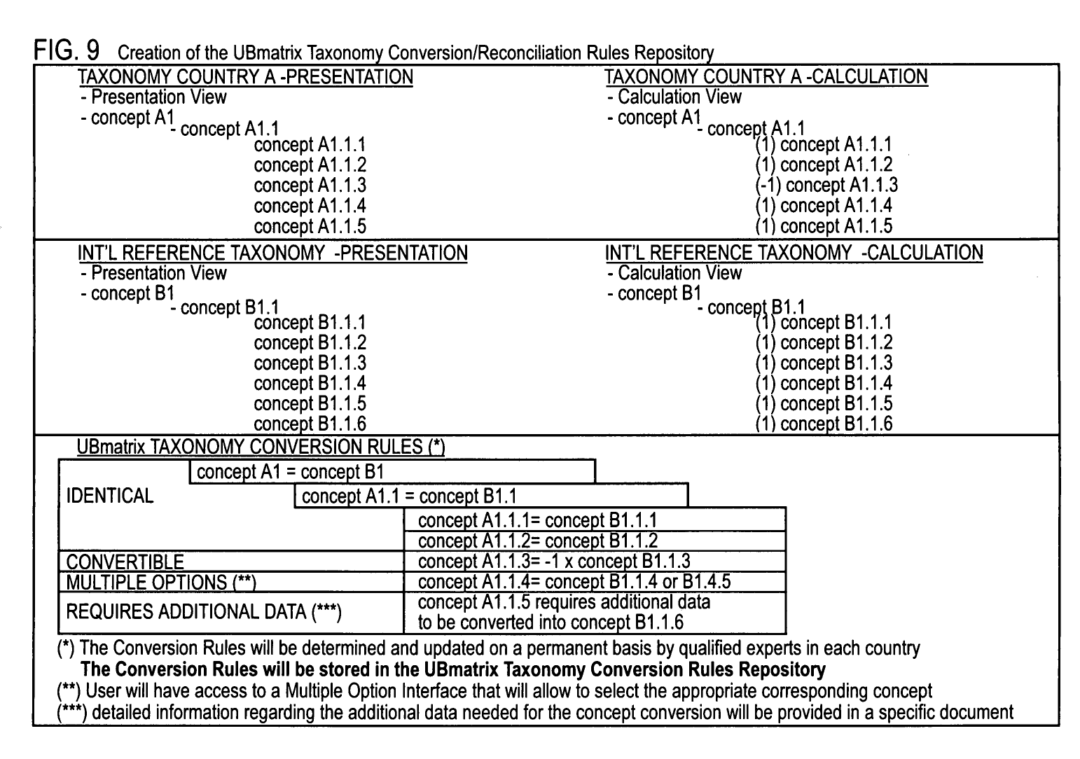

FIG. 9 outlines an exemplary approach described with respect to FIG. 4. The XBRL Presentation, Calculation (and other) metadata for Country A is converted into complementary Presentation, Calculation, etc. metadata in a single international reference Taxonomy, that functions for example as the single intermediate standard reference metadata. This reference Taxonomy can then be used as desired to construct target Taxonomies as needed for other countries. In an exemplary embodiment, rules enable efficient automated Taxonomy conversion, and improve automation of manual conversion where fully automatic conversion is not possible.

Four exemplary scenarios for element-level metadata conversion are described in FIG. 9, and each can be ultimately expressed in terms of a rule or set of rules.

In a first scenario, “Identical”, an element in a first taxonomy is identical to an element in a second taxonomy. In this simplest case, the element in the first Taxonomy (metadata) set is directly mapped to the corresponding element in the second Taxonomy (metadata) set.

In a second scenario, “Convertible”, a metadata element can be automatically calculated from a source element. This can be like an Identical scenario but with a scalar multiple or other mathematical function also applied as part of the mapping.

In a third scenario, “Multiple Options”, where a metadata element in a first taxonomy can correspond to two or more different elements in a second taxonomy, the metadata element can be resolved through the intermediation of some other agent. The agent can be, for example, a human operator, interacting with the mapping process via a software interface, or an algorithm such as an “expert system”. In exemplary embodiments, a user will have access to a Multiple Option Interface that will allow or enable the user to select an appropriate corresponding concept, e.g. an XBRL Concept.

In a fourth scenario, “Requires Additional Data”, the metadata element can only be resolved through the addition of other data. This data can be supplied, for example, by a human operator (e.g. a human operator interacting with the mapping process via a software interface), or by an algorithm such as an “expert system”. In some cases additional data may always be required, in other cases the data may only need to be provided once and thereafter arises as the first or second scenario. In an exemplary embodiment, detailed information regarding the additional data needed can be provided in a specific document, for example to which the user can be automatically referred or provided access.

Conversion rules associated with the scenarios, can (but are not required to) be determined and updated on a permanent basis by qualified experts associated with the source and destination taxonomies or standards on which the taxonomies are based.

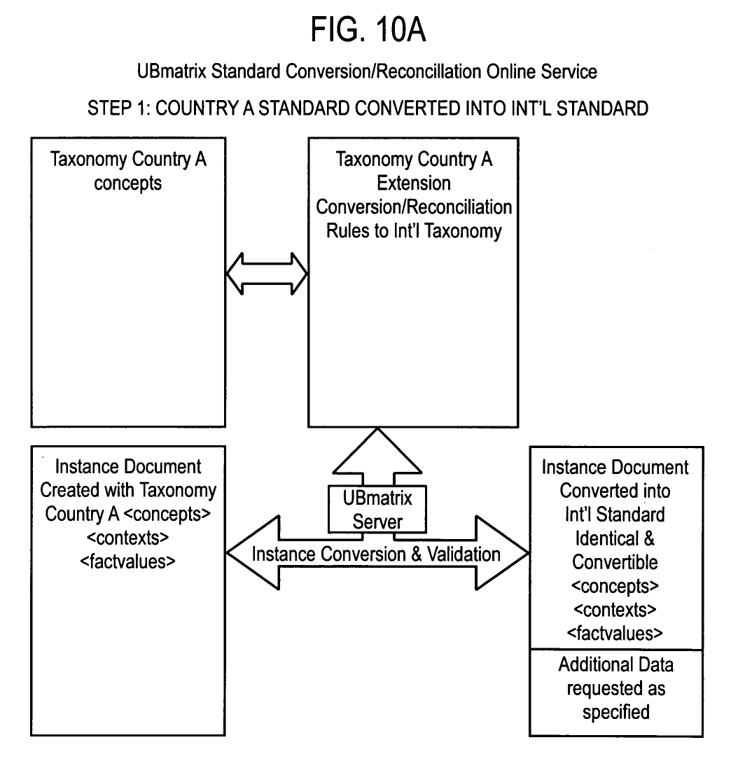

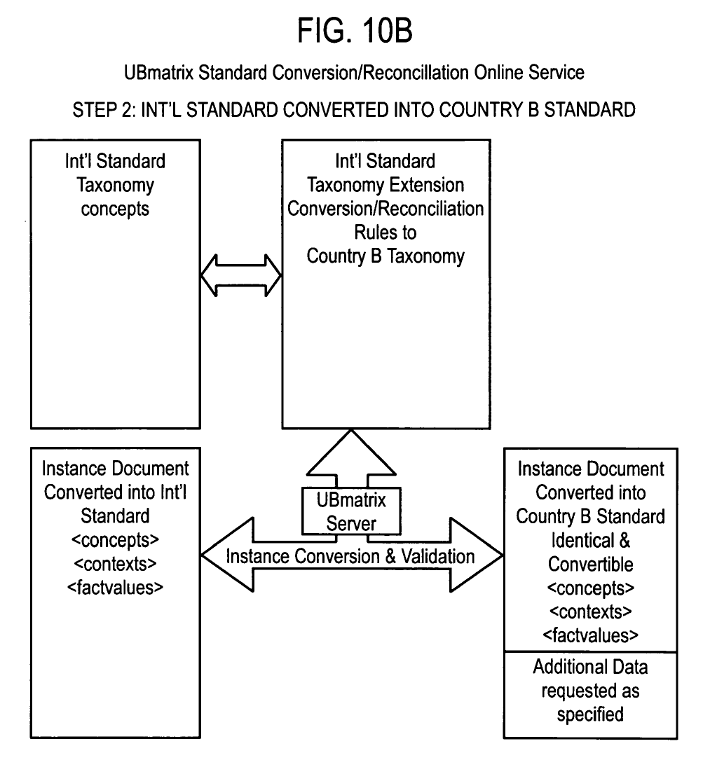

In exemplary embodiments of the present invention, in the scenarios described above, when information linking, associating or mapping concepts between taxonomies is required and is not known, then it is obtained automatically or by querying a user to provide the information. For example, one or more “dictionaries”, databases or other sdocuments associated with a conversion between a first taxonomy and/or instance document and a second taxonomy and/or instance document can (individually or collectively) include a list of direct correspondence between elements or concepts, as in the first scenario, and can also include rules or formulas that specify exact relationships between elements or concepts, as for example in the second scenario. In addition, the dictionary can include rules that specify a sequence of actions to be automatically performed when the third and fourth scenarios occur, for example a specific sequence of queries or choices presented to the user. The dictionary or document(s) can be added to or refined based on user's answers to queries, and so forth. Adding to and refining the dictionary or other documents associated with converting between the same two taxonomies or between two instance documents, enables later conversions between those two taxonomies or between a different pair of instance documents that have a similar structure (e.g., converting a business report of the same company but from a different time period) to be more automated and efficient. The Taxonomy Extension Conversion/Reconciliation Rules shown in FIGS. 10A, 10B are exemplary dictionary/mapping documents.

FIG. 10A graphically depicts an exemplary process of conversion of metadata from a first Taxonomy to an intermediate representation or Taxonomy, for example an “international” Taxomony. FIG. 10A also shows conversion of an instance document based on the first Taxonomy, to an instance document based on a second, intermediate Taxonomy. As shown in FIG. 10A, the UBMatrix server can use the Rules found in the extensions, and the rules can include or specify actions to query a user for additional information, a qualitative decision or selection, and so forth, consistent with the principles described herein. For example, the Rules can coverall of the situations and scenarios shown in FIG. 9. FIG. 10B graphically depicts a similar exemplary process of conversion of metadata from the second, intermediate Taxonomy to a third Taxonomy. FIG. 10B also shows conversion of an instance document (data and metadata) based on the second, intermediate Taxonomy, to an instance document based on the third Taxonomy.

Those skilled in the art will realize that intermediate representations of Taxonomies can be saved for later use, for example when another Instance document having the same initial structure but different data is encountered. Intermediate representations of Instance documents can also be saved if desired.

In exemplary embodiments, an intermediary repository of metadata reference sets and conversion rules is used for both Taxonomy and Instance metadata and data conversion. The repository can be a server, for example the “UBmatrix Server” shown in FIGS. 10A, 10B. This server serves as a centralized electronic repository for XBRL Taxonomy specifications and for conversion rules for both metadata and data. The XBRL language provides some support for the construction and management of such a repository through the XBRL concepts of Extension Taxonomies and Formulas.

Generally, “rules” can be applied to convert or alter data, for example conversion of a monetary value from U.S. dollars to Japanese yen, whereas “metadata reference sets” are used to convert metadata or labels associated with data, for example from one taxonomy consistent with U.S. GAAP, to another taxonomy consistent with Japanese Accounting Principles. Thus, conversion may involve either or both of rules and metadata reference sets. For example, to convert a taxonomy (e.g., a metadata structure having no data entries) to the intermediate representation or intermediate taxonomy that is consistent with a superset intermediate taxonomy, for example an international reference Taxonomy, only an appropriate metadata reference set is necessary to perform the conversion. After the conversion the resulting intermediate representation or taxonomy, which can be a subset of the superset intermediate taxonomy, can also be saved for future use. When an Instance document that conforms with a new or unique taxonomy is first encountered, then in an exemplary embodiment a metadata reference set is used to convert the metadata to an intermediate representation consistent with the intermediate taxonomy, and rules are also used to convert the data to values consistent with the intermediate taxonomy for insertion into the intermediate representation or Instance document. As with the example where only a taxonomy was converted, the metadata portion (or taxonomy) of the intermediate representation can be saved. Thus when another Instance document conforming to the new or unique taxonomy is encountered later, only the rules need be applied to convert the values for insertion into a copy of the (saved) intermediate representation, or in other words added to the saved intermediate taxonomy.

Using an intermediate superset taxonomy can provide additional advantages, for example when the intermediate superset taxonomy is designed to embody or require best practices or characteristics. In this case when converting from a first taxonomy to the intermediate superset taxonomy or vice versa, the intermediate superset taxonomy can act as a filter whereby anomalies, deficiencies or opportunities for improvement in the first taxonomy are automatically identified as part of the conversion process. Attempting to convert the first taxonomy into a form consistent with the intermediate superset taxonomy, or attempting to construct a first taxonomy from the intermediate superset taxonomy, can reveal aspects or characteristics of the first taxonomy that are incompatible or inconsistent with the intermediate superset taxonomy.

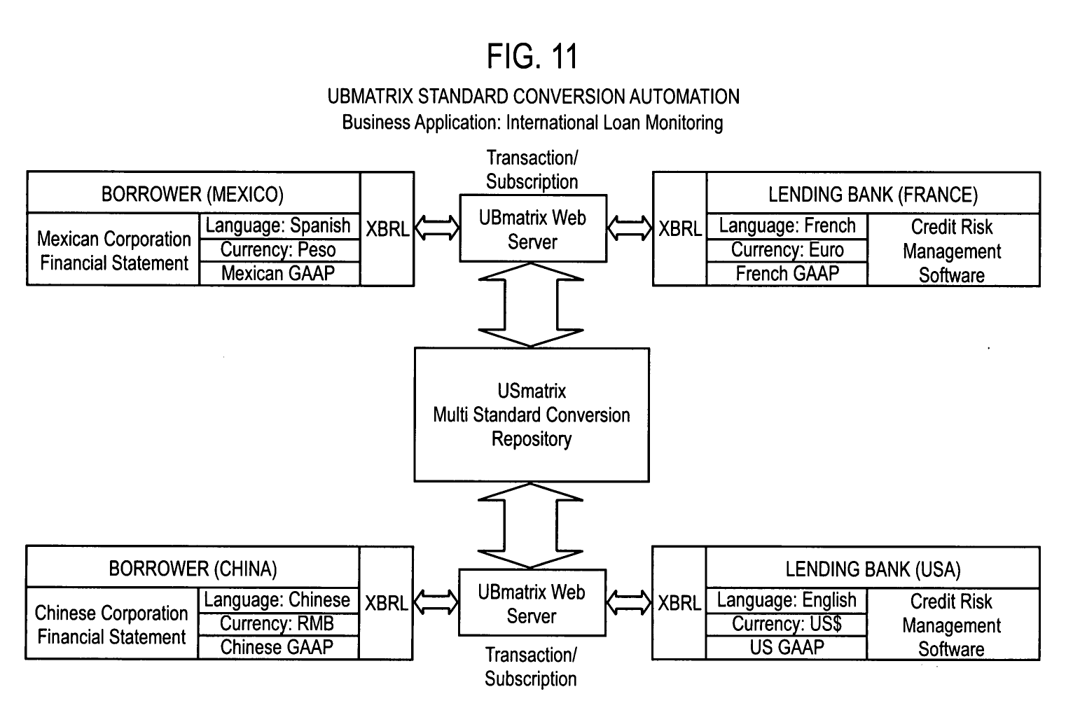

FIG. 11 illustrates an exemplary application where a centralized “Multi-Standard Conversion Repository” is used to support automatic conversion of XBRL Instance documents from one form to another. In this example, using XBRL metadata (including formulae) and other rules stored in the server repository, Instance documents produced in Mexico and China are converted into instance documents which can be consumed by software in France and the United States, respectively. Human or software agents can also be provided as needed to resolve the Multiple Options and/or Additional Data Needed scenarios as described herein with respect to FIG. 9.

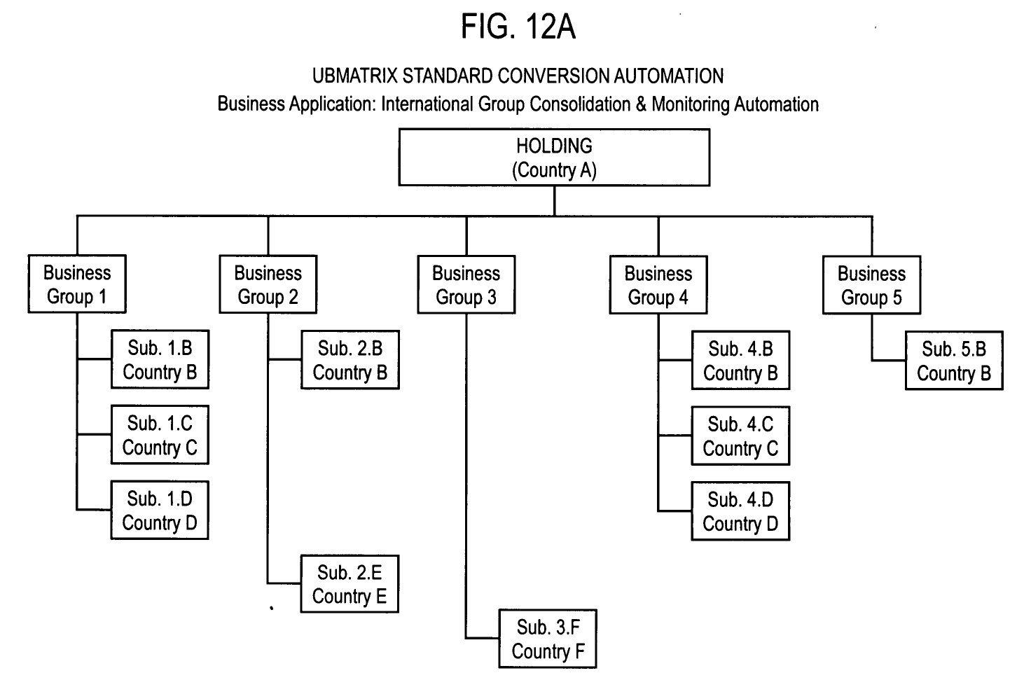

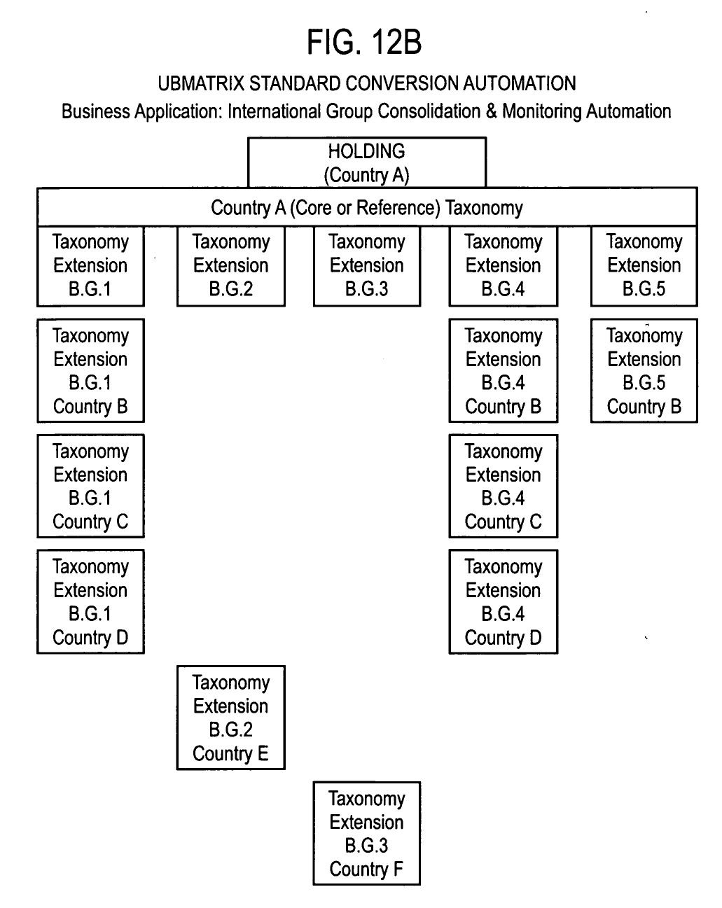

FIGS. 12A, 12B illustrate an exemplary structure and arrangement of XBRL metadata, relying upon the XBRL concept of Extension Taxonomies, to support a hierarchy of re-useable metadata. In FIG. 12A, “Business Group 1”, “Business Group 2”, “Business Group 3”, “Business Group 4”, and “Business Group 5” each have specialized metadata which relies upon a base set of metadata defined for their parent, identified as the “HOLDING” Company. This structure is re-iterated in FIG. 12B, with the concepts of XBRL Extension Taxonomies introduced.

Within the structure shown in FIGS. 12A, 12B, further extensions of each first-level extension are possible. For example, within Business Group 1, Countries “B”, “C” and “D” may have metadata extensions which themselves rely upon both the Business Group 1 metadata extensions and the base-level metadata.

In exemplary embodiments of the invention, although Taxonomy extensions are dependent upon their parent metadata set to be usable, all Taxonomies, whether “base” or extensions, are modular and can be individually identified and independently managed. This feature supports the rational organization and efficient operation of a server environment, where many different Taxonomies are likely to be simultaneously in use for a wide variety different applications.

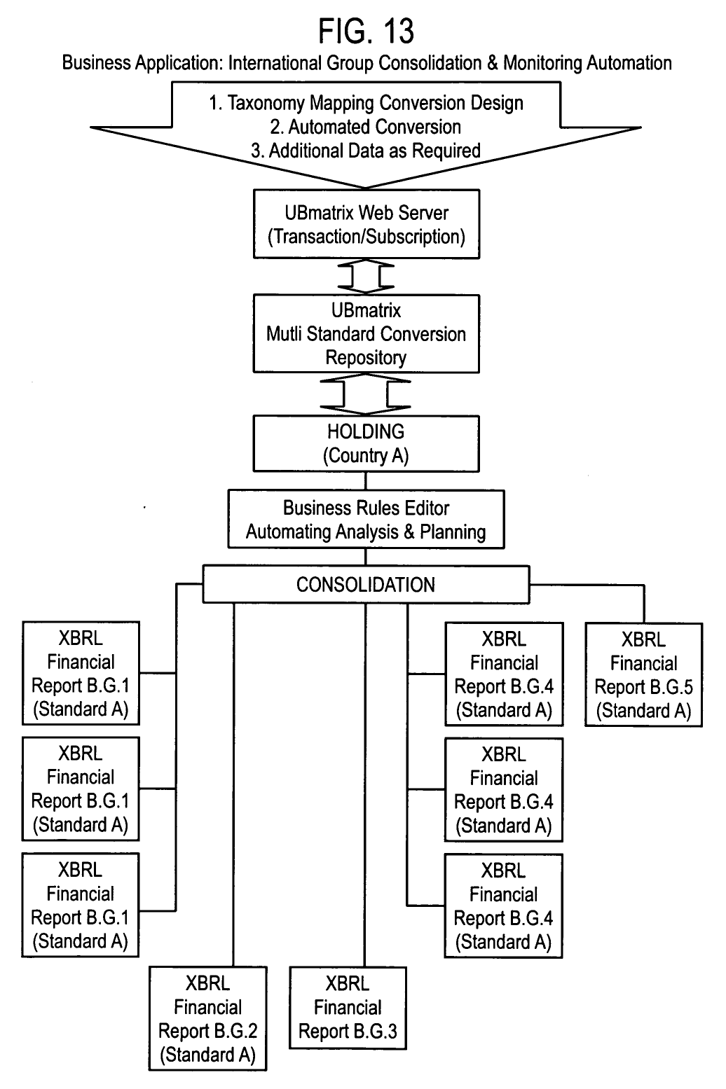

FIG. 13 illustrates an exemplary application of the use of the metadata arrangement described in FIGS. 12A, 12B. In FIG. 13, a multi-national firm with different business groups can use a centralized server (for example, the UBMatrix Multi-standard Conversion Repository shown in FIG. 13) for automated conversion and consolidation of various Instance document data sets. In exemplary embodiments, these processes can be wholly or partially driven by metadata rules and formulae.

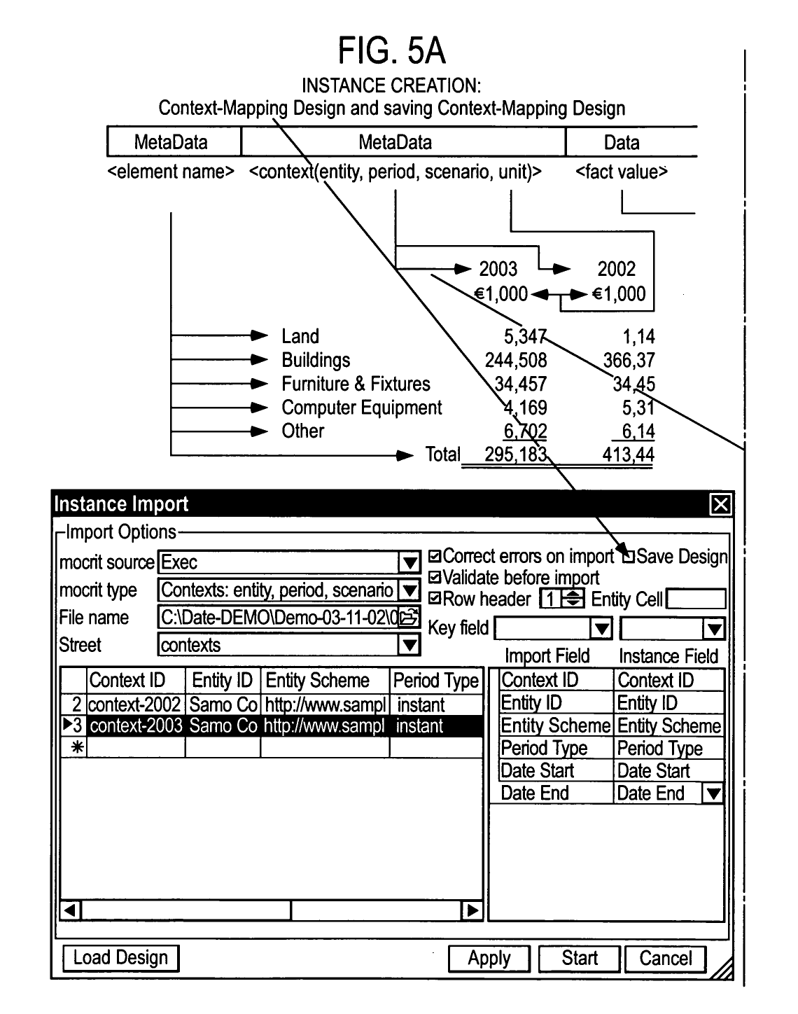

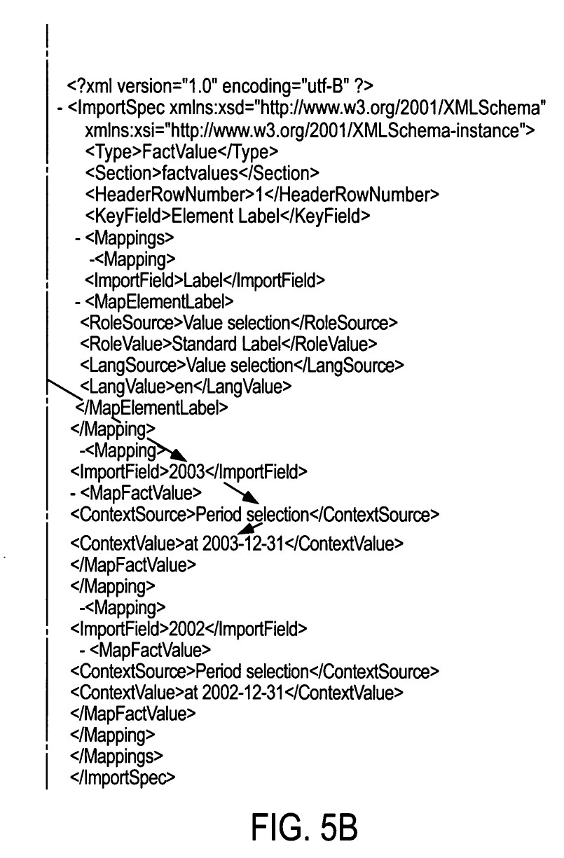

FIG. 5 illustrates how Instance document metadata can be collected for later re-use. In this example, the initial source Instance document is a Microsoft Excel spreadsheet. When first encountered, only the metadata which can be derived from the Excel document are available. Manual processing of some sort is therefore needed to evaluate the Instance document. A software application, for example Universal Business Matrix's Automator product, can be used to import and manipulate the original Excel spreadsheet. In an exemplary embodiment, human action is required to map Excel metadata elements in the Instance into an XBRL Taxonomy. The interface shown in The bottom portion of FIG. 5 shows a portion of an exemplary Automator interface during this process of initial mapping. Once done the first time, the “design” for this mapping from the initial source Instance document can be saved for later re-use during conversion of a similar Instance document. On the right side of FIG. 5 is a fragment of the XBRL Taxonomy metadata constructed for the sample Instance document described in FIG. 4, related for example to the data and metadata shown in the upper left of FIG. 5. If the metadata for an Instance document do not change over time, then the Taxonomy metadata created when the document was initially encountered can be used to automate, in whole or in part, all future conversions of the Instance document, or of Instance documents having the same structure of metadata and data but different data values (e.g. fact values).

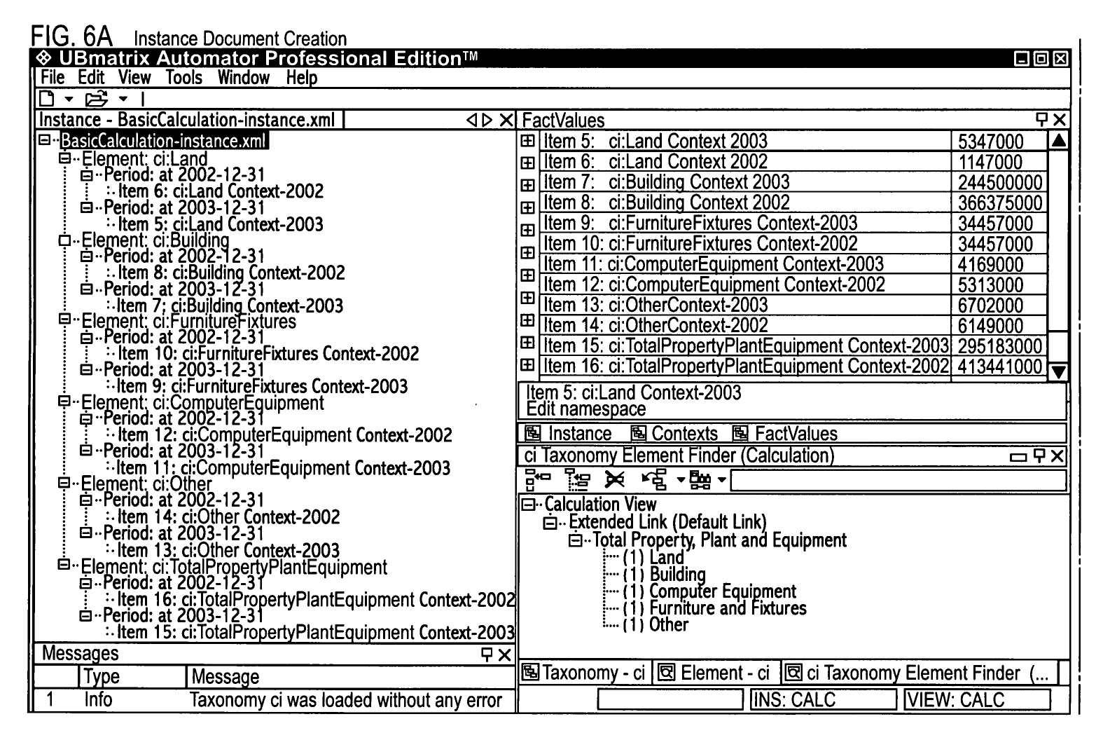

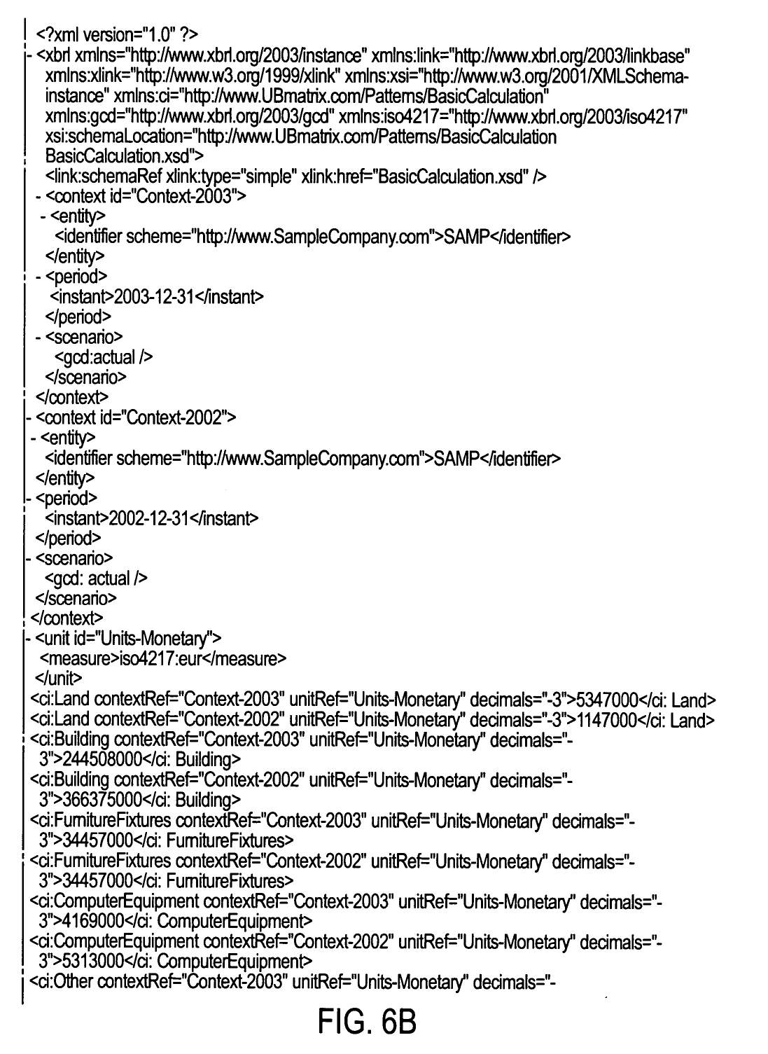

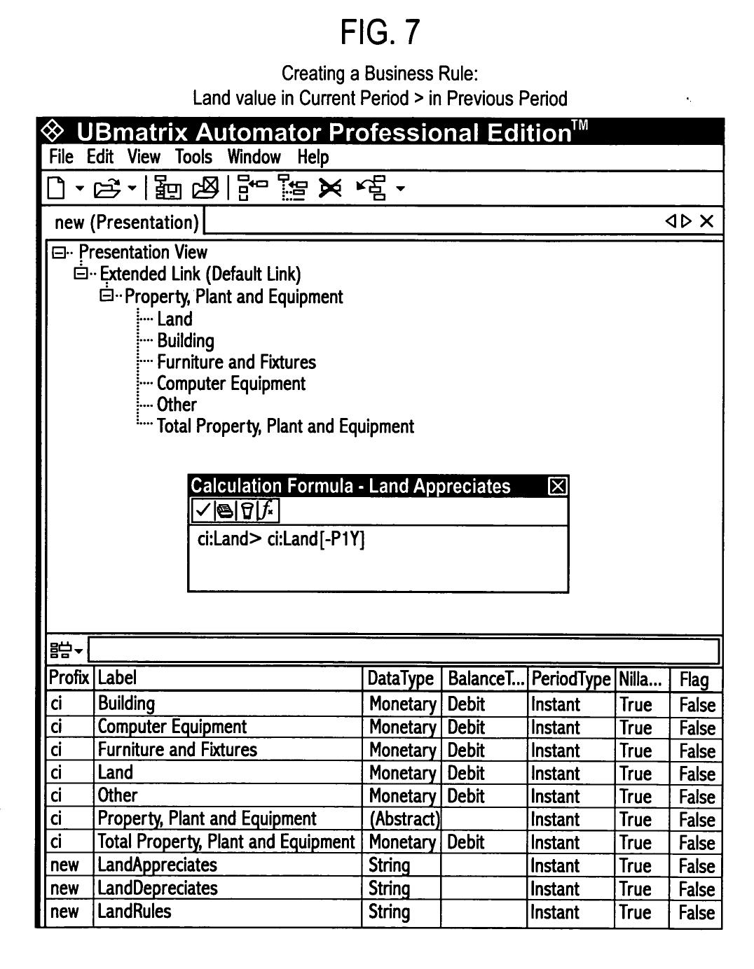

In accordance with an exemplary embodiment, FIG. 6 illustrates operation of Universal Business Matrix's Automator software during Instance document creation. XBRL results are shown on the right side of FIG. 6. In FIG. 6, the metadata of interest is the Calculation view of the “Land” data element, which can be used, for example in the fashion shown in FIG. 7 to describe the use of formulae to specify data conversion rules.

FIG. 7 illustrates an exemplary process for the creation of a rule for use in conversion or creation of Instance documents, using an exemplary interface of Universal Business Matrix's Automator. The desired “business rule” is that land value for the current accounting period should be greater than the land value for the immediately preceding period. Shown in the center of FIG. 7 is a small window where a human software operator can specify the rule, using for example standard algebraic notation and element names from relevant XBRL metadata (e.g. from a relevant Taxonomy). The expression “caLand>ciLand[-PTY]” should be read as “Is Current Instance Land Greater Than Current Instance Land [Of The Prior Period Year]”. The result from any evaluation of this formula will always yield either a binary TRUE or FALSE or create all kinds of output as, and non exclusively, derived values and automated steps in a pre-defined work flow. The formula can be stored in an extension of the corresponding taxonomy, e.g. for future use.

The pre-defined work flow can include, for example, querying a user for data or a qualitative decision. For example, where the source taxonomy or instance document based on a first standard lacks a value required in a destination taxonomy or instance document based on a second, destination standard, for example a market value of an asset, then the user can be queried in accordance with the formula, and asked to provided the desired datum. A qualitative decision can involve, for example, a situation where a concept in the source taxonomy or standard has a rough but not exact equivalent concept in the destination taxonomy or standard, and the importance of the difference between the concepts can depend on specific circumstances, for example an overall asset value of a company whose business report is contained in the instance document being converted. In this situation, the user can be queried and provided with a choice whether to accept or decline the equivalence, or select a different concept in the destination taxonomy or standard that should be used instead. The formula or rule can be more elaborate. For example, the rule can be set so that if the overall asset value of the company is less than a threshold value, then the conversion is automatically performed, but if the overall asset value of the company is greater than or equal to the threshold value, then the user is queried. Other variations are possible. For example, the user can be queried to provide a numeric factor or select a particular mathematical conversion function, that can vary depending on risk perceived by the user, size of the company, or any other circumstance or circumstances internal or external to the company, that affects the conversion or reconciliation.

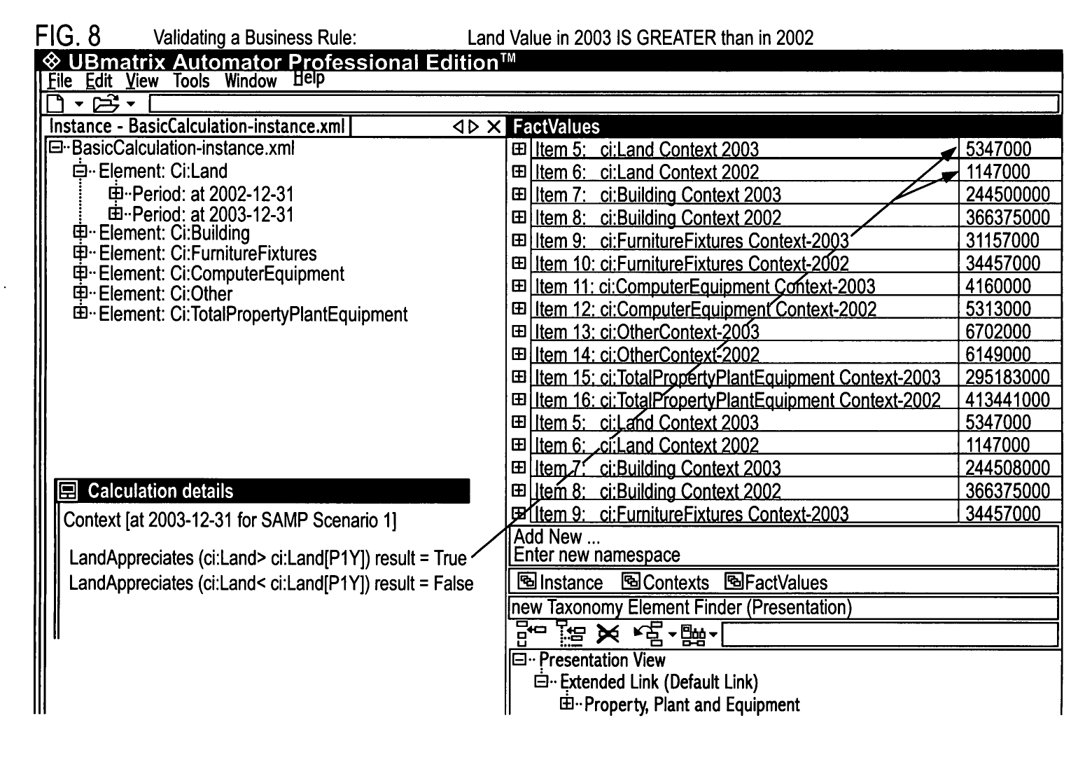

FIG. 8 illustrates the use of a previously specified rule. In this case, the Land Value rule described in FIG. 7 is evaluated during validation of data in an Instance document.

A centralized repository, for example the centralized repository described in FIG. 11, can enable Instance documents, individually or in batch sets, to be validated and/or converted using the pre-defined rules. In such a case, the interfaces variously shown can be augmented or replaced with one or more interfaces more appropriate for human or electronic exception processing.

In an exemplary embodiment, conceptual metadata, contextual metadata and a fact value of a first schema or taxonomy are associated with each other and are converted into different conceptual metadata, different contextual metadata and a different fact value of the second schema or taxonomy. For example, the associated contextual metadata can identify a monetary currency and the associated fact value can identify an amount of the monetary currency.

Throughout this disclosure XBRL is customarily used as the exemplary metadata expression language, and we use terminology and examples which are XBRL-specific. However, this use of XBRL for exemplary purposes is not intended to limit the invention to XBRL or XML languages.

The methods, logics, techniques and pseudocode sequences described above can be implemented in a variety of programming styles (for example Structured Programming, Object-Oriented Programming, and so forth) and in a variety of different programming languages (for example Java, C, C++, C#, Pascal, Ada, and so forth). In addition, those skilled in the art will appreciate that the elements and methods or processes described herein can be implemented using a microprocessor, computer, or any other computing device, and can be implemented in hardware and/or software, in a single physical location or in distributed fashion among various locations or host computing platforms. The computer or computing device (central or distributed) can include a display for displaying any of the data and information described herein, and for displaying or implementing the exemplary user interfaces variously shown in the Figures. The display can, for example, display logical correspondence or mapping between two instance documents and/or taxonomies or schemas or elements thereof, and the source and/or destination/result instance documents. A machine readable medium can include software or a computer program or programs for causing a computing device to perform the methods and techniques described herein.

Those skilled in the art will appreciate that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. A method for converting a first set of data having a first logical structure into a second set of data having a second logical structure, wherein the first and second sets include metadata, the method comprising:
classifying an element of the first set of data;
automatically selecting a rule relating the element of the first set of data to the second set of data, based on the classification;
executing the rule to convert the element of the first set of data to an element of the second set of data based on the selected rule;
storing a logical correspondence between the element of the first set of data and the element in the second set of data based on the conversion, in the event information is received from a user in response to an automatic query performed by execution of the rule; and
repeating the classifying, converting and storing for each element in the first set of data.

2. The method of claim 1, wherein the first set of data is a source taxonomy and the second set of data is an intermediate taxonomy.

3. The method of claim 1, wherein the first set of data is an intermediate taxonomy, and the second set of data is a destination taxonomy.

4. The method of claim 1, wherein the first set of data comprises a first Instance document based on a first taxonomy, and the second set of data comprises a second Instance document based on a second taxonomy.

5. The method of claim 1, wherein element classifications comprise:
a first classification wherein an element name in the first set of data is identical to an element name in the second set of data;
a second classification wherein an element in the second set of data is a mathematical function of an element in the first set of data;
a third classification wherein an element in the first set of data corresponds to multiple elements in the second set of data and one of the correspondences is selected based on a pre-existing rule or on an instruction received from a human user; and
a fourth classification wherein an element name in the first set of data is associated with an element name in the second set of data based on an instruction received from a human user.

6. The method of claim 5, wherein the first and second sets of data are instance documents.

7. The method of claim 6, comprising receiving an instruction from a human user.

8. A method for converting a first set of data elements having a first logical structure based on conceptual metadata of a first schema or a first taxonomy, into a second set of data elements having a second logical structure associated with conceptual metadata of a second schema or a second taxonomy, wherein the first and second sets include conceptual metadata from the corresponding schema or taxonomy, contextual metadata and fact values, the method comprising:
classifying a data element of the first set of data, the classifications being based on logical correspondences between concepts of the first and second schemas or taxonomies and including a) a classification wherein the semantic of a concept of the first schema or taxonomy is identical to a concept of the second schema or taxonomy, b) a classification wherein a concept of the first schema or taxonomy is related to a concept of the second schema or taxonomy by a mathematical function that converts the fact value associated with the concept of the first schema or taxonomy into a fact value associated with the corresponding concept of the second schema or taxonomy, c) a classification wherein conversion of a concept of the first schema or taxonomy requires a selection among different options for conversion of a fact value associated with the concept of the first schema or taxonomy into a fact value associated with a corresponding concept of the second schema or taxonomy, and d) a classification wherein conversion of a concept of the first schema or taxonomy requires additional information for conversion of a fact value associated to with the concept of the first schema or taxonomy into a fact value associated with a corresponding concept of the second schema or taxonomy;
automatically selecting a rule relating the data elements of the first set of data to the second set of data, based on the classification;
executing the rule to convert the element of the first set of data to an element of the second set of data based on the selected rule;
storing a logical correspondence between the element of the first set of data and the element in the second set of data based on the conversion, in the event information is received from a user in response to an automatic query performed by execution of the rule; and
repeating the classifying, converting and storing for each element in the first set of data.

9. The method of claim 8, wherein conceptual metadata, contextual metadata and a fact value of the first schema or taxonomy are associated with each other and are converted into different conceptual metadata, different contextual metadata and a different fact value of the second schema or taxonomy.

10. The method of claim 9, wherein the associated contextual metadata identifies a monetary currency and the associated fact value identifies an amount of the monetary currency.

11. A system for converting a first set of data having a first logical structure into a second set of data having a second logical structure, wherein the first and second sets include metadata, the system comprising:
means for classifying an element of the first set of data, automatically selecting a rule relating the element of the first set of data to the second set of data, based on the classification, executing the rule to convert the element of the first set of data to an element of the second set of data based on the selected rule, storing a logical correspondence between the element of the first set of data and the element in the second set of data based on the conversion, in the event information is received from a user in response to an automatic query performed by execution of the rule, and repeating the classifying, converting and storing for each element in the first set of data; and
a display for displaying at least one of the logical correspondence and the second set of data.

12. A machine readable medium comprising a computer program for causing a computation device to convert a first set of data having a first logical structure into a second set of data having a second logical structure, wherein the first and second sets include metadata, by performing:
classifying an element of the first set of data;
automatically selecting a rule relating the element of the first set of data to the second set of data, based on the classification;
executing the rule to convert the element of the first set of data to an element of the second set of data based on the selected rule;
storing a logical correspondence between the element of the first set of data and the element in the second set of data based on the conversion, in the event information is received from a user in response to an automatic query performed by execution of the rule; and
repeating the classifying, converting and storing for each element in the first set of data.
